(19) United States
(12) Patent Application Publication
(10) Pub. No.: US 2014/0308473 A1
(43) Pub. Date: Oct. 16, 2014

(54) THREE DIMENSIONAL STRUCTURES DERIVED FROM PLANAR PANELS

(71) Applicant: Noble Environmental Technologies Corporation, San Diego, CA (US)

(72) Inventor: Robert Noble, Encinitas, CA (US)

(73) Assignee: Noble Environmental Technologies Corporation, San Diego, CA (US)

(21) Appl. No.: 14/223,666

(22) Filed: Mar. 24, 2014

Related U.S. Application Data
(60) Provisional application No. 61/812,681, filed on Apr. 16, 2013.

(51) Int. Cl. B32B 3/08; B05D 3/12; B32B 38/00; B32B 3/30

(52) U.S. Cl. CPC B32B 3/08; B32B 3/30; B05D 3/12; B32B 38/0004; B32B 38/0012
USPC 428/64.1; 428/189; 427/290; 156/211; 156/60

(57) ABSTRACT

A three-dimensional structure comprising a plurality of substantially planar sections and an adhesive layer. The planar sections are oriented in stacked relation with one another. The adhesive layer binds the sections in substantially fixed relation with one another. In exemplary embodiments, the sections may be formed from a single piece or from plural pieces. The three-dimensional structure is formed by positioning the respective sections on a retainer and affixing them in place in relation to one another.

### CROSS-REFERENCE TO RELATED APPLICATION

This application claims priority to U.S. Application No. 61/812,681, entitled, “Three Dimensional Structures Derived From Planar Panels”, and which was filed Apr. 16, 2013, the entirety of which is referred to and incorporated herein by reference in its entirety.

### FIELD OF THE DISCLOSURE

The disclosure that follows relates to three dimensional structures derived from two dimensional planar components.

### BACKGROUND

Various forms of three dimensional structures are known, from utilitarian objects such as plates, baskets, musical instruments, and bowls, to artistic objects such as sculptures, or mixed artistic and utilitarian structures such as architectural panels or decorative elements. It is known to create such three dimensional structures from a myriad of materials and techniques. Examples are shaping or sculpting wood or rock, or forming clay or ceramics, or cutting materials, such as wood, metals, plastics etc. Likewise machine based processes can be used, such as molding or cutting.

Although the wide variety of known materials and techniques can produce a wide array of structures, improvements upon the materials or techniques may produce a greater variety of structures, or not yet known objects of beauty and function. Moreover, there is a need for materials and techniques that reduce consumption of nonrenewable resources, and still provide cosmetic and functional appeal. Accordingly, there is a need for structures and techniques for assembling structures providing three-dimensional structures of different design and cosmetic properties, and which optionally are fabricated of renewable or waste resources.

### SUMMARY

The present disclosure, in its many embodiments, alleviates to a great extent the disadvantages of producing three-dimensional (three dimensional) objects from generally planar materials by modifying the planar materials through the use of one or more slots or cuts, aligning of the slotted or cut planar element in desired three dimensional positions and stabilizing or fixing the three dimensional position, such as using adhesives and/or binding members. A retainer, such as a jig, may be used in positioning the cut piece or pieces into desired positions relative to one another.

In one embodiment of the invention, a substantially planar board, also referred to as a 2-D or two dimensional board, is formed into one or more cut pieces by placing cuts defined in the planar board. The cut piece or pieces are formed into a desired structure with a first wall or inner wall and a second wall, or outer wall, and an adhesive (also called binder). The adhesive is applied substantially fixes all or a portion of the cut pieces in relation to one another, setting the desired structure.

Any material may be used for the planar board, such as cardboard, wood or metal. In one embodiment, the planar board is made from engineered molded fiberboard panels or other material that provides a desired level of rigidity, density and pliability. It is desired that the material and thickness be selected to provide sufficient rigidity and structural integrity to be cut or machined as desired, and also to provide surfaces that can receive and be bound with the adhesive selected. Likewise, it is generally desired that the material be sufficiently rigid and dense so as to maintain each strip's integrity during the slight bending required to create the three-dimensional forms.

Any suitable adhesive or binder can be used that provides a sufficient level of adhesion to fix the cut piece or pieces in relation to one another. In one embodiment a resin based adhesive is used. In other embodiments, pigmentation is mixed in with the adhesive to impart a desired color to the structure. The outer walls of the final structure can be secured by the addition of rib bridges or planar bridges that may provide structural effects, such as stabilization, and also any desired cosmetic effect.

In a single cut embodiment, a planar board is provided and a single continuous cut is made, such as resulting in a continuous slot. The continuous slot may optionally be a spiral, such as extending from the outer edge to a location in the interior of the planar board. In an alternate embodiment, two or more continuous cuts are made, but the piece retained as a single piece. This single cut piece may be placed on a jig, and fixed by the application of adhesive, forming a spiral containing three dimensional structure. Optional bridges also may be adhered to the outer or inner surfaces of the structure.

In another embodiment of the invention, two substantially planar boards are cut, either with continuous or discreet cuts, in a desired pattern. Then the cut pieces are positioned as desired on a retaining structure or jig and fixed into position by the application of an adhesive.

The structures may have any desired shape or size as can be produced by the cutting and positioning of the cut planar boards in accordance with the invention. Likewise, the planar boards optionally can be fabricated of compressed cellulosic materials and/or waste materials, providing economic and environmental advantages.

Other objects and advantages of the present invention will become more evident hereinafter in the specification and drawings.

### BRIEF DESCRIPTION OF THE DRAWINGS

The foregoing and other objects of the disclosure will be apparent upon consideration of the following detailed description, taken in conjunction with the accompanying drawings, in which:

FIG. 1 is a plan view of a planar board in accordance with the invention;

FIG. 2 is a plan view of a cut planar board in accordance with the invention;

FIG. 3 is a plan view of a cut planar board in accordance with the invention;

FIG. 4 is an elevation view of a form retainer in accordance with the invention;

FIG. 5 is a cross-sectional view of a form retainer and cut pieces in accordance with the invention;

FIG. 6 is a cross-sectional view of a form retainer and cut pieces in accordance with the invention;

FIG. 7 is a cross-sectional view of a form retainer and cut pieces in accordance with the invention;

FIG. 8 is a cross-sectional view of a structure in accordance with the invention;

FIG. 9 is a perspective view of a form retainer in accordance with the invention;

FIG. 10 is a plan view of a cut board in accordance with the invention;

FIG. 11A is an elevation view of a structure in accordance with the invention;

FIG. 11B is a plan view of the structure illustrated in FIG. 11A

FIG. 12 is a cross-sectional detail view of a portion of the structure illustrated in FIGS. 11A and 11B;

FIG. 13A is a cross-sectional detail view of a structure in accordance with the invention;

FIG. 13B is a bottom plan view of the structure illustrated in FIG. 13A;

FIG. 14A is a cross-sectional detail view of a structure in accordance with the invention;

FIG. 14B is a bottom plan view of the structure illustrated in FIG. 14A;

FIG. 15 is a plan view of cut boards in accordance with the invention;

FIG. 16 is a cross-sectional view of a structure in accordance with the invention;

FIG. 17 is a cross-sectional detail view of a portion of the structure illustrated in FIG. 16;

FIG. 18A is a cross-sectional detail view of a structure in accordance with the invention;

FIG. 18B is a bottom plan view of the structure illustrated in FIG. 18A;

FIG. 19A is a cross-sectional detail view of a structure in accordance with the invention;

FIG. 19B is a bottom plan view of the structure illustrated in FIG. 19A;

FIG. 20 is an exploded view of a structure in accordance with the invention;

FIG. 21 is a side elevation of a structure in accordance with the invention;

FIG. 22 is a plan view of a cut board with a single continuous spiral cut in accordance with the invention;

FIG. 23 is an elevated view of a structure in accordance with the invention derived from a planar board having a continuous cut;

FIG. 24 is a cross-sectional detail view of a portion of the structure illustrated in FIG. 23;

FIG. 25 is a cross-sectional detail view of a structure in accordance with the invention derived from a planar board having a continuous cut, with an inside bridge;

FIG. 26 is a cross-sectional detail view of a structure in accordance with the invention derived from a planar board having a continuous cut, with an outside bridge;

FIG. 27 is an exploded view of a structure in accordance with the invention;

FIG. 28 is a side elevation of a structure in accordance with the invention;

FIG. 29A illustrates a cut board pattern in accordance with the invention;

FIG. 29B illustrates a cut board pattern in accordance with the invention;

FIG. 29C illustrates a cut board pattern in accordance with the invention;

FIG. 29D illustrates a cut board pattern in accordance with the invention;

FIG. 29E illustrates a cut board pattern in accordance with the invention;

FIG. 29F illustrates a cut board pattern in accordance with the invention;

FIG. 29G illustrates a cut board pattern in accordance with the invention; and

FIG. 29H illustrates a cut board pattern in accordance with the invention.

### DETAILED DESCRIPTION

In the following paragraphs, embodiments will be described in detail by way of example with reference to the accompanying drawings, which are not drawn to scale, and the illustrated components are not necessarily drawn proportionately to one another. Throughout this description, the embodiments and examples shown should be considered as exemplars, rather than as limitations of the present disclosure. As used herein, the “present disclosure” or “present invention” refer to any one of the embodiments described herein, and any equivalents. Furthermore, reference to various aspects of the invention throughout this document does not mean that all claimed embodiments or methods must include the referenced aspects or features.

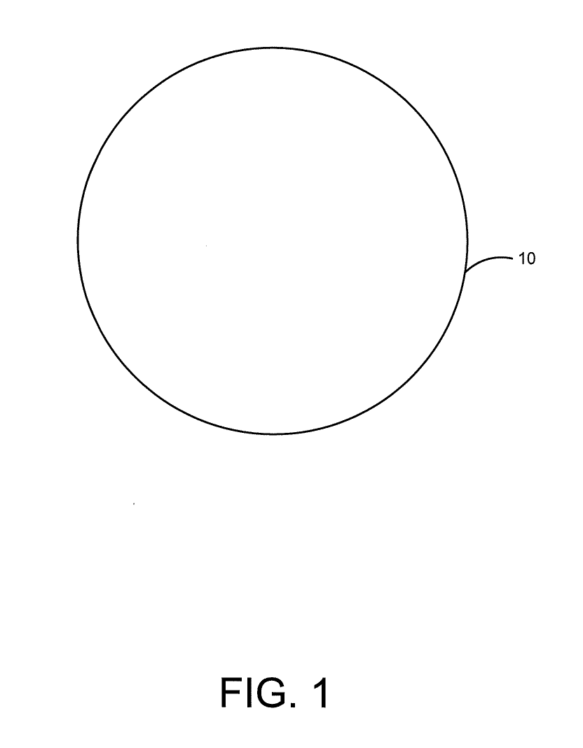

A generally planar board 10 is illustrated in FIG. 1. The generally planar board 10 is the basic building element from which the three dimensional structures of this disclosure are derived. The board 10 may be formed of any material and thickness that will impart the physical properties and structural integrity desired of the final three-dimensional structure created. For example, thicker boards 10 may yield (but not always depending on application of adhesives, cut width etc.), more rigid structures. Examples of some materials for the board 10 include cardboard, paperboard wood, cellulosic composites, compressed cellulose material blends, brass, stainless steel, or other metals, polymeric materials or other cellulosic based products, or combinations of these materials. The material and thickness of the board 10 should be selected so as to be susceptible to cutting as desired. It is desired that the material and thickness be selected to provide sufficient rigidity and structural integrity to be cut or machined as desired, and also to provide surfaces that can receive and be bound with the adhesive selected. Some examples of suitable molded and/or compressed cellulose based materials are discussed in commonly owned U.S. patent application Ser. No. 12,412,554, entitled, “Engineered Molded Fiberboard Panels and Methods of Making and Using the Same: and U.S. patent application Ser. No. 12,412,780, entitled, “Engineered Molded Fiberboard Panels, Methods of Making the Panels, and Product Fabricated From the Panels,” both of which are referred to and incorporated herein in their entireties (collectively referred to as the Incorporated Applications).

Examples of some criteria to use in the selection of material and thickness of the planar board 10 are to provide sufficient rigidity, density and consistency to be machinable to allow for precise slot cuts, and to maintain the structural integrity of each cut piece under the stresses that may be imposed by bending or other forces applied in positioning the cut pieces to achieve a desired final shape or orientation. Other desired traits of the materials selected for the boards 10 are that they provide desired traits of being sufficiently ductile, plastic and/or pliable so that the material can be positioned to achieve a desired final shape or orientation.

Any shape or size may be selected for the generally planar board 10. The selection of size or shape of the board depends upon the desired structure of the final product. For example, the shape of the generally planar board 10 may be round, oval, elliptical, triangular, square, hexagonal or of a complex shape. Also, any desired thickness may be used for the generally planar board 10. Determination of the thickness depends upon the structural characteristics desired, but the thickness should provide sufficient structural integrity and pliability.

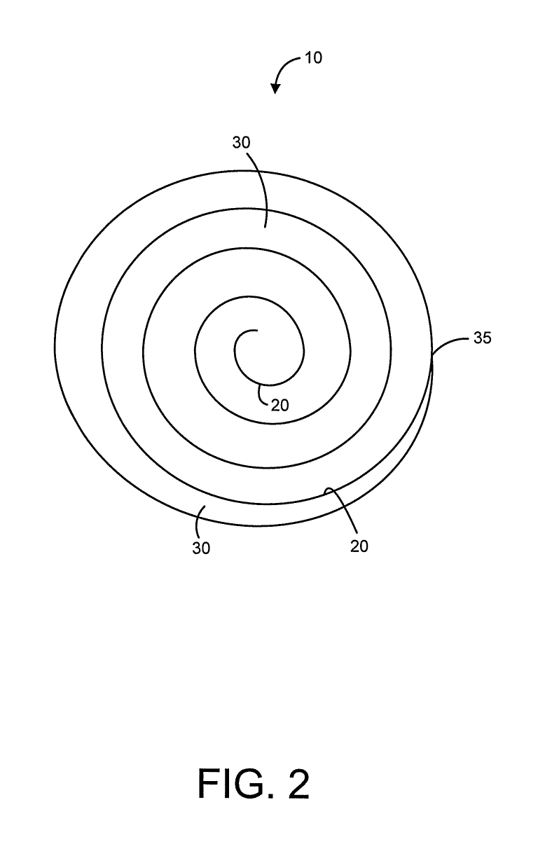

As illustrated in FIG. 2, cuts 20 are made into the generally planar board 10. In the embodiment shown in FIG. 2, a continuous spiral cut 20 is applied to the planar board providing a single spiral cut piece 30. The spiral cut piece 30 shown in FIG. 2 is formed by making a continuous cut of decreasing radii from an outer edge 35 towards the center of the generally planar board 10. Any desired pattern may be cut into the planar board 10 to achieve the desired size and shape of the final product.

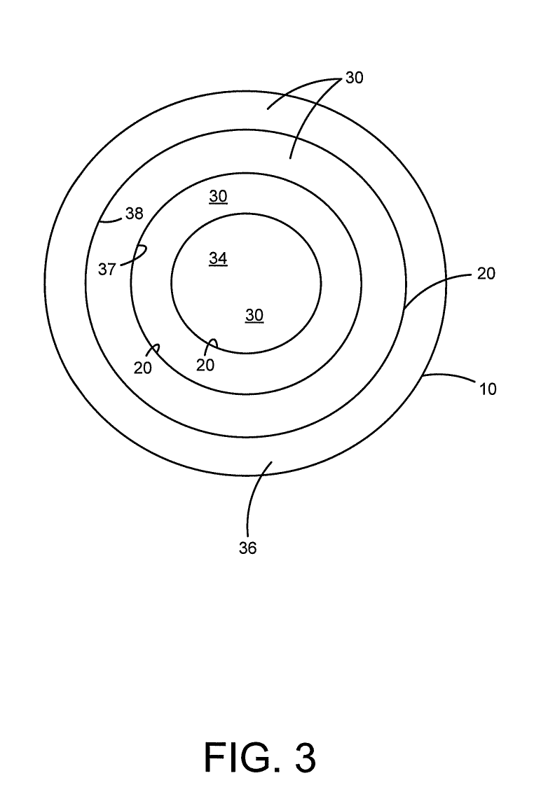

FIG. 3 illustrates another example of another pattern of cuts 20 in the planar board 10. In this embodiment, multiple cuts 20 are provided. In the illustrated example, a concentric pattern of cuts 20 is shown, creating multiple cut pieces 30 in concentric rings or increasing diameters from the innermost cut piece 34 to the outermost 36. Each of the cut pieces 30 includes an inner wall 37 and outer wall 38, the inner wall 37 having a shorter perimeter than the outer wall 38. In the illustrated embodiment only one of the respective inner walls 37 and outer walls 38 are labeled.

It should be noted that although FIG. 3 illustrates a single board 10 cut in concentric rings 30 by cuts 20, multiple boards 10 also can be cut in the same pattern, and combined into a final desired structure, having varying diameters of rings 30, some being of identical diameter and sharing other similar dimensions, and others of different dimensions. In one example, round tube can be formed as a final structure by stacking cut pieces 30 of the same dimensions on top of one another and then affixing.

Different shapes of cut pieces 30 also can be created in different embodiments, similar to the varying shapes and sizes of the generally planar board. For example, the cut pieces may be round, oval, elliptical, triangular, square, hexagonal or an desired simple or complex shape. In one embodiment the shape of planar board is selected to be the same as the desired shape of the cut pieces. For example, a round board may be cut in a concentric ring pattern. Or in another example, a triangular board is cut into triangular pieces. An advantage of selecting the board shape to correspond to the desired shape of the cut pieces is to reduce material waste.

The machine or technique for making cuts 20 may be determined by the material properties of the board and the pattern of the cuts desired. For example, for easily cut materials, or relatively simple shaped cuts, suitable instruments might include hand operated knives or blades. For materials that are more difficult to cut, such as harder materials, or for relatively more complex cuts 20, machines such as machine saws, band saws, jig saws, water jet cutters, CNC routers or laser cutters may be utilized, although such automated or machine cutters may also apply simple cuts or be used for more easily cut materials as well.

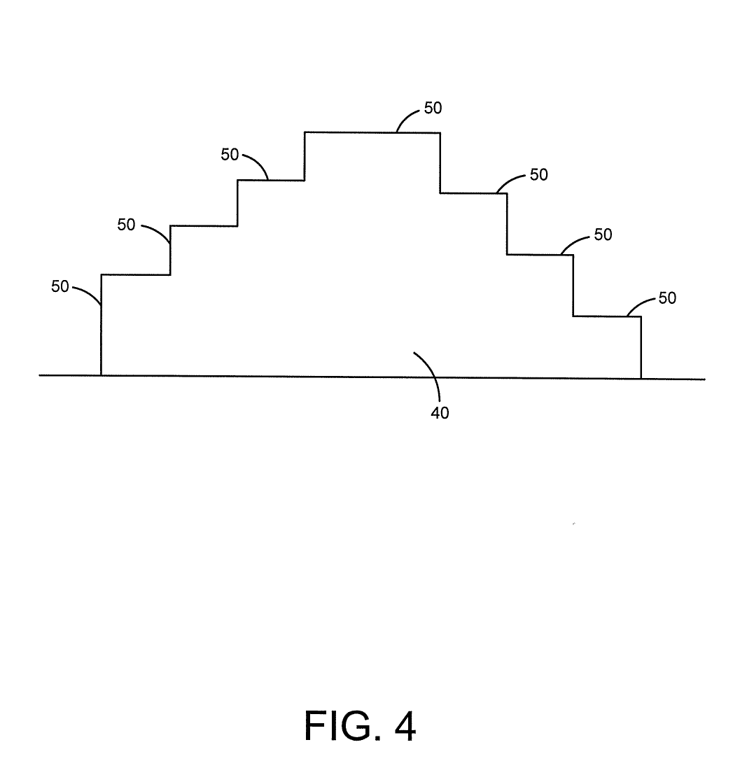

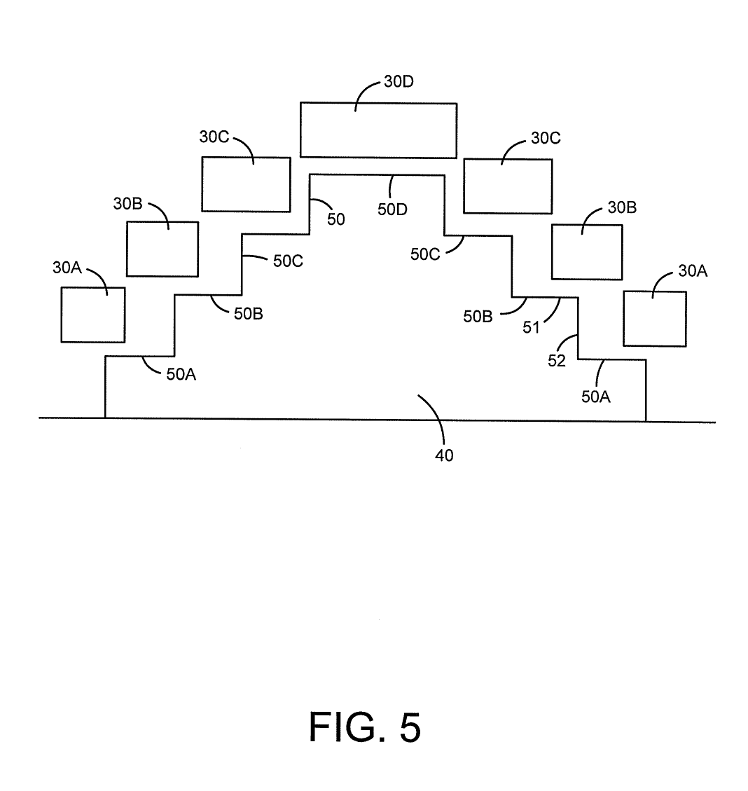

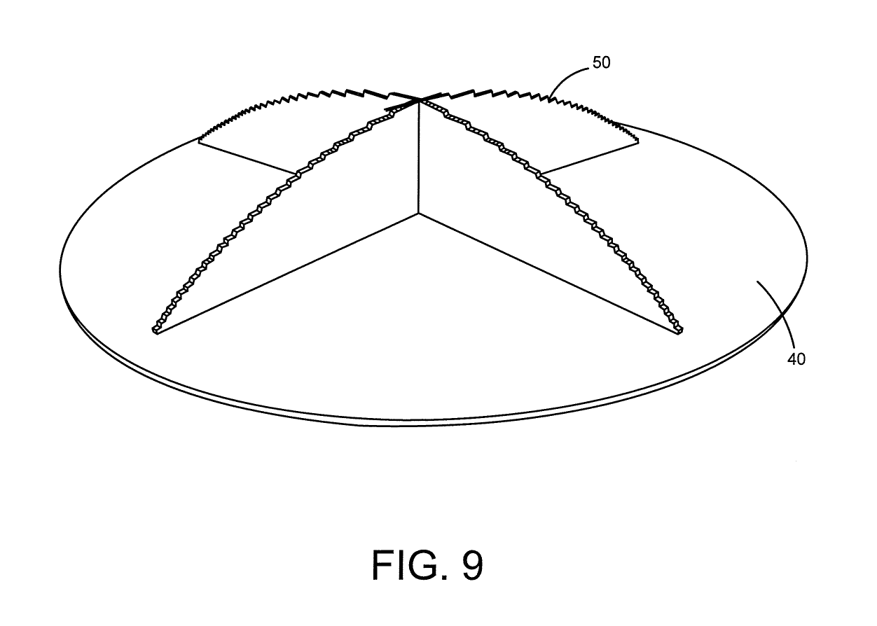

FIGS. 4-7 illustrate a sample form retainer embodiment in which form retainer 40 is used to in positioning cut pieces 30 in assembly of a desired three-dimensional structure. FIGS. 4 and 9 illustrate examples of suitable form retainers 40 without pieces 30 positioned on them. The form retainer 40 may of any desired profile that positions the pieces 30 in desired positions. Retaining surfaces 50 may be incorporated into form retainer 40. In the illustrated embodiments, the retaining surfaces 50 are steps, although it should be appreciated that any desired retaining surface may be used that provides sufficient support for positioning the cut piece(s) 30 as desired. Likewise the retaining surfaces 50 may be of heights or lengths depending on the desired characteristics of the three-dimensional structure. For example, the embodiment illustrated in FIGS. 5-7 illustrates the steps 50 on the left and right sides of the illustrated cross-section of the form retainer being at relatively similar elevations. As another example, the embodiment illustrated in FIG. 4 shows the steps 50 staggered, with the height of the steps on the right side offset from those on the left. Such a form retainer might be particularly suitable for a single-cut or spiral cut embodiment of the invention discussed herein.

In this description, the term “steps” is used interchangeably with “retaining surfaces” and it should be understood that the use of either term is to describe a structure or means of positioning the cut pieces 30. In the steps 50 embodiment, the steps 50 have individual horizontal and vertical surfaces 51, 52, forming the steps. Other examples of retaining surfaces 50 are ledges and angled or sloped surfaces.

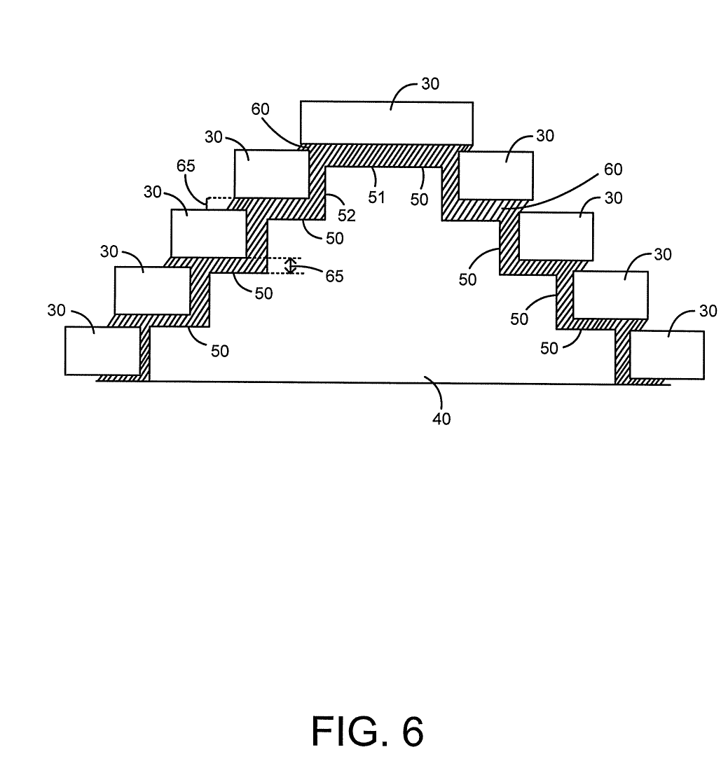

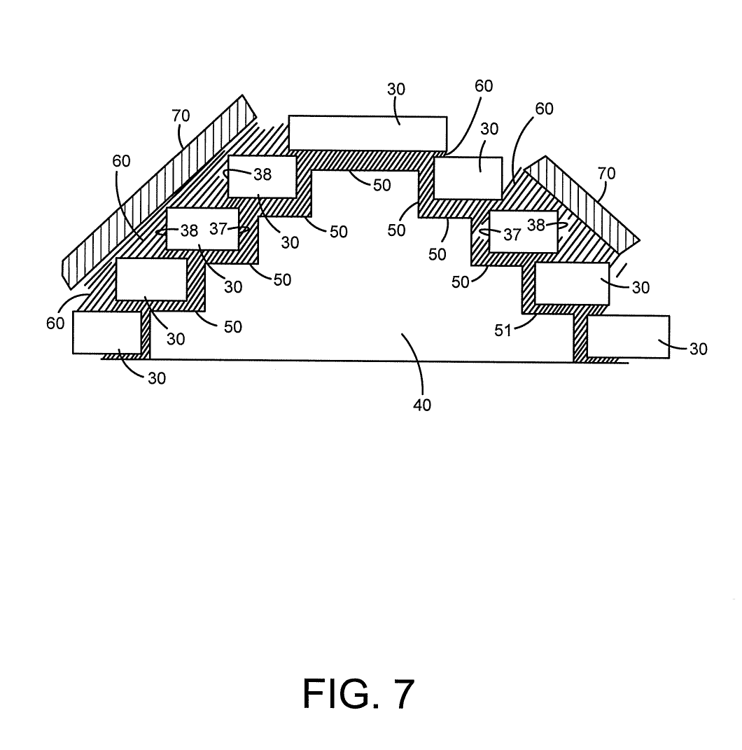

A form retainer with positioned cut pieces 30 is illustrated in FIGS. 5-7. In the illustration shown in FIG. 5, concentric ring cut pieces 30A-30C are illustrated. In FIGS. 6 and 7 overlapping ring pieces 30 are illustrated. The cut pieces 30 are placed on the steps 50, with the largest diameter cut piece 30A positioned on the largest diameter step 50A. Other rings are provided as well as illustrated with reference symbols 30B and 30C. In the example shown, the second largest diameter cut piece 30B is positioned on the second largest diameter step 50B and so on for piece 30C and step 50C. This stacking is continued until the cut pieces are positioned as desired. In the illustrated embodiment, the final piece 30D, which may be of any desired shape, such as a circle or ring or any other shape, is positioned on a top step 50D. A similarly shaped step retainer 40 might be used for other examples, such as a continuously cut spiral piece 30 or any other.

In the example illustrated in FIG. 6, the cut pieces 30 are positioned on steps 50 of the form retainer 40. A binder or adhesive 60 is illustrated as being positioned in the spaces between the pieces 30 and also between the pieces 30 and the form retainer 40. Any material 60 can be selected as long as it has sufficient strength to retain the structural integrity of the desired three-dimensional structure. For example, the material 60 can be an adhesive binder, resin material or coating, and the term “adhesive” or “binder” as used herein is used to mean any material desired that may retain pieces 30 in a generally desired position in a formed structure. The adhesive 60 itself may provide desirable features wanted in the final product such as a particular coloring, water resistance or thermal conductivity. Examples of methods of application of resin or adhesive 60 include brushing or spraying. Other criteria for selecting an adhesive 60 can increase the tensile strength, provide UV resistance and fluid resistance for the cut pieces 30.

Spaces 65 may be provided between the cut pieces 30 to allow for penetration of the adhesive 60 into the space but narrow enough to allow for adequate bridging between the crevasse face by the adhesive 60. It is noted that although the illustrations show different width of spaces 65, it should be appreciated that any desired width may be selected, and in addition, in some embodiments, there is no space or gap between the form retainer 40 and one or more of the pieces 30, or between respective pieces 30. As the adhesive 60 sets, the cut pieces 30 are set in generally firm fixed positions with respect to one another, thereby setting the shape of the final three-dimensional structure. Once the adhesive 60 sets sufficiently, the final product can be removed from the form retainer 40.

In addition to adhesive 60, there are options to fix cut pieces 30 in their desired orientations. For example, mechanical binders, such as bridges, rivets, screws or bolts can be used. These and other examples may provide both aesthetic value as well as structural integrity. Illustrated in FIG. 7, two bridges 70 are positioned adjacent to the outer walls 38 of some of the cut pieces 30. The bridges 70 may be any size or shape, depending upon the function it is providing. For example, the bridges 70 may perform both structural and cosmetic purposes. In addition, the bridge may come in any desired shapes, such as strips, leaves, letters, ribs or any other desired shape or thickness. In one example, using letters for the bridges 70, one can personalize the three-dimensional structure such as by forming the letters into a name, initials, message, slogan, or brand.

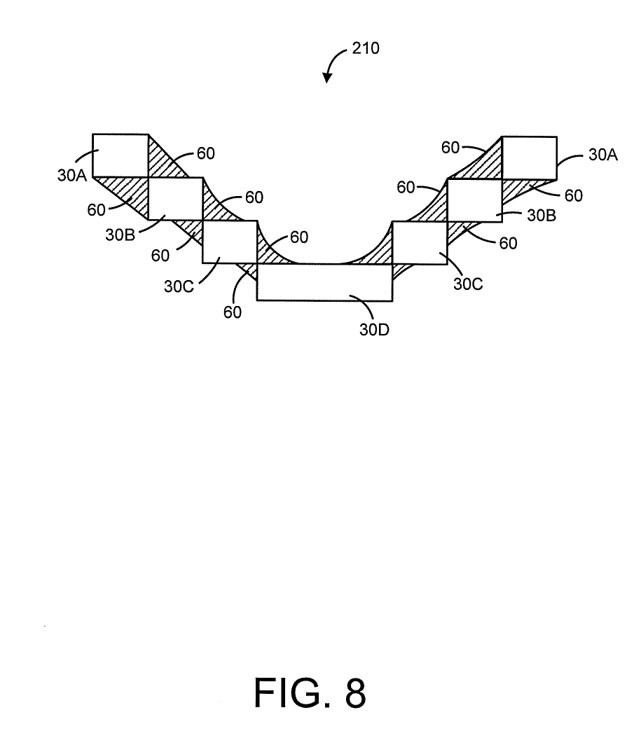

FIG. 8 illustrates an example of a final product or three-dimensional structure 210 in accordance with the invention. It should be noted that the terms “three-dimensional structure” or “structure” or “final product” or “product” are used in this description for the structure in which one or more of the cut pieces 30 are retained in a desired relation with respect to one another, such as for example, after adhesive 60 and/or bridges are applied and the structure is removable from the form retainer 40. The structure illustrated in FIG. 8 corresponds to the embodiment illustrated in FIG. 5 as well, in which concentric pieces 30A, 30B and 30C are provided. A dried adhesive layer 60 also is illustrated. The dried adhesive layer may cover all or some of the interstitial spaces between the pieces 30 (i.e., 30A through 30D) or alternatively, may coat the entirety of the both sides or one side of the structure 210.

The structure 210 may serve any desired purpose, whether cosmetic or functional or both. Some examples of final products 210 are bowls, plates, baskets, planters, planting pots, trays, vases, speakers, speaker cabinets, architectural elements or panels, acoustic panels, lamps and lighting fixtures, picture frames, sculptural works, musical instruments such as violins, guitars, cellos, ukuleles, or drums, shaped or curved beams and so on.

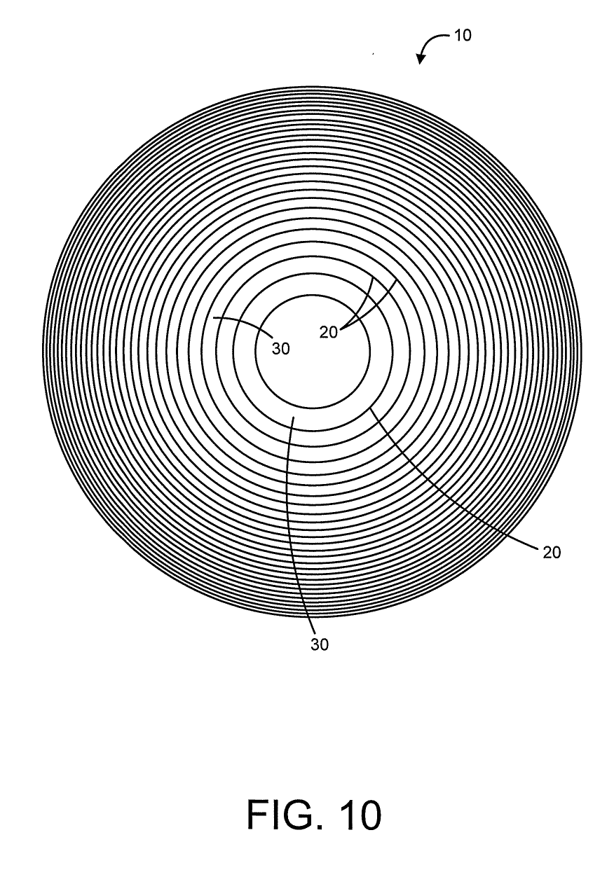

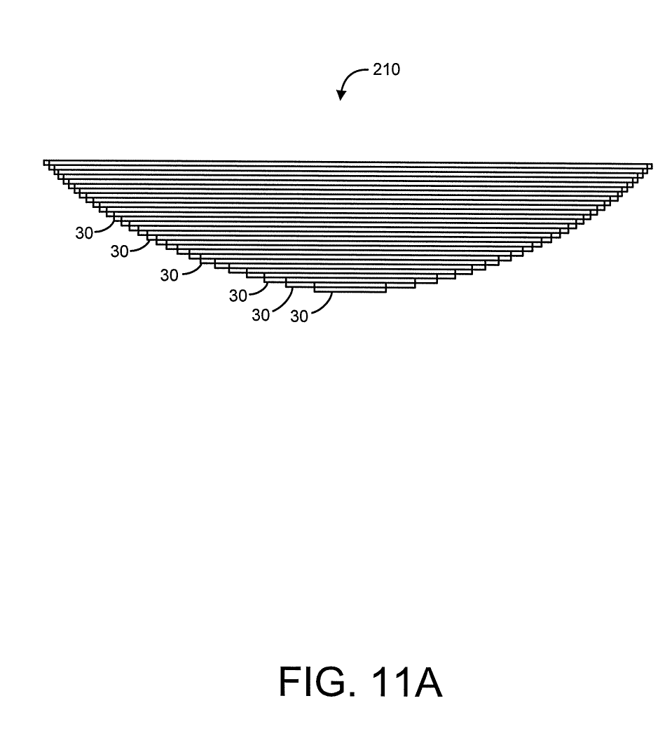

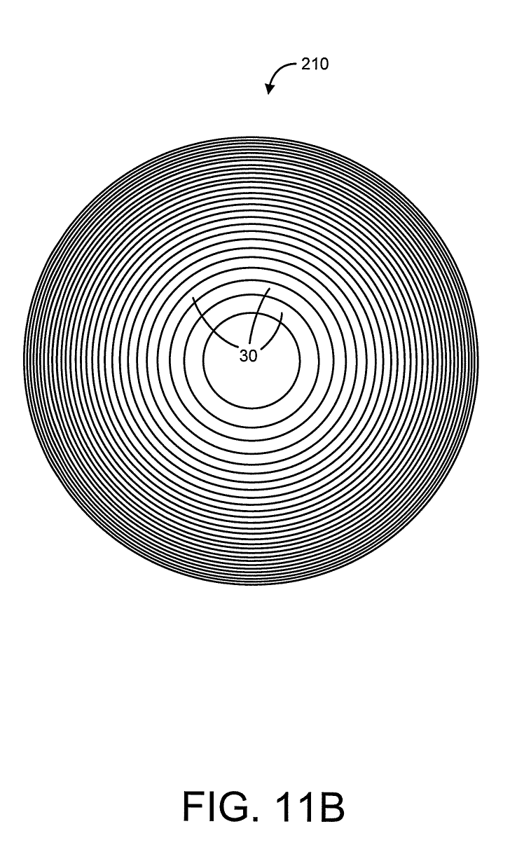

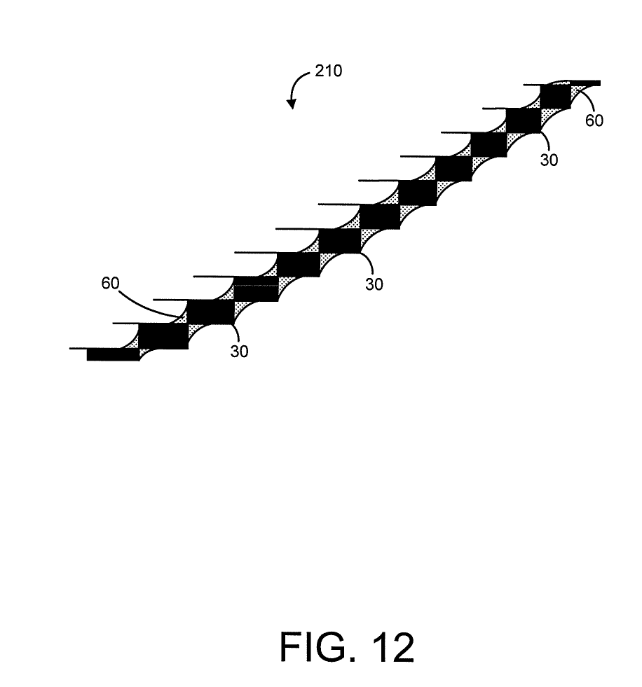

Further examples of the invention are shown in FIGS. 10 through 29. FIGS. 10-14, illustrate a single planar board 10 embodiment of the invention. FIG. 10 illustrates a cut circular board with concentric rings. FIGS. 11A and 11B illustrate a final structure 210. FIG. 12 illustrates a detail view of a right side of the structure 210 of FIG. 11, showing the aligned cut sections 30, with adhesive layer 60 on both an inside and outside of the structure 210, and between the pieces 30.

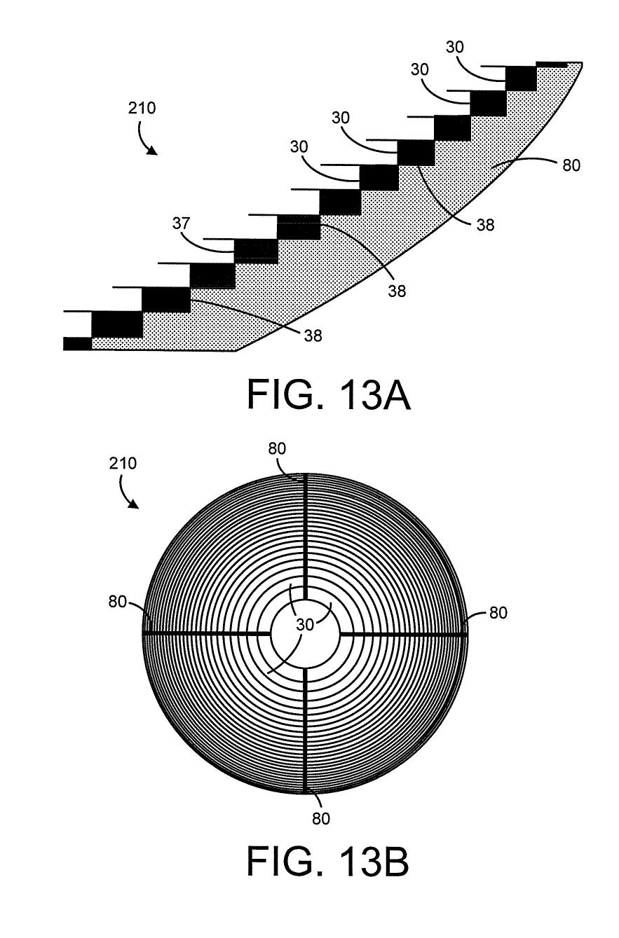

FIGS. 13A and 13B illustrate an example of rib bridges 80 positioned to align and set the pieces 30. It should be understood that rib bridges are a type of bridge 70, and are separately discussed here to refer to bridges that may have some horizontal depth, or be non-planar. However, it should be understood that the term “bridge” herein applies to all different types of bridges, including rib bridges 80. In this example a rib bridge 80, or multiple rib bridges 80, are positioned adjacent the outer surfaces 38 of the cut pieces 30. In this illustration, rib bridge 80 spans the entire length of a side of the structure 210. The rib bridges 80 may be any shape or width, depending upon the function desired. Similar to the bridges 70, rib bridges 80 may serve both functional purposes or cosmetic purposes or both. Adhesive 60 is typically used to attach rib bridges 80 to the cut pieces 30. It should be understood that in fabrication, in one embodiment, it is possible to use the rib bridges 80 to align the cut piece 30 or pieces 30, rendering a retainer structure 40 or jig unnecessary. In this embodiment, the rib bridges 80 have steps positioned as desired to orient the piece(s) 30 as desired.

Determining which embodiment to employ can depend on the characteristics desired. In FIG. 12, the cut pieces 30 are secured and set into a final product 210 by an adhesive 60 only connection. In FIG. 13, the cut pieces 30 are secured and set into a final product 210 by a combination of a rib bridge connection 80 and adhesive 60.

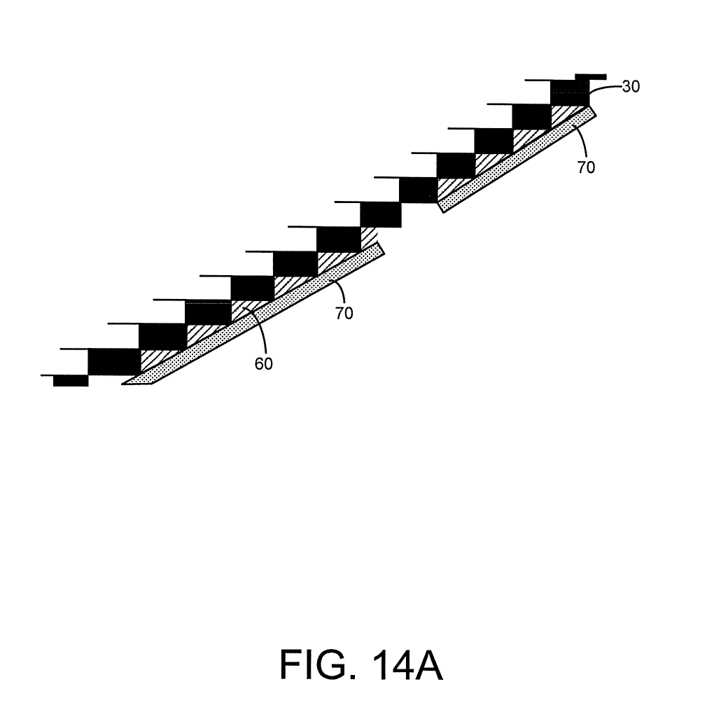

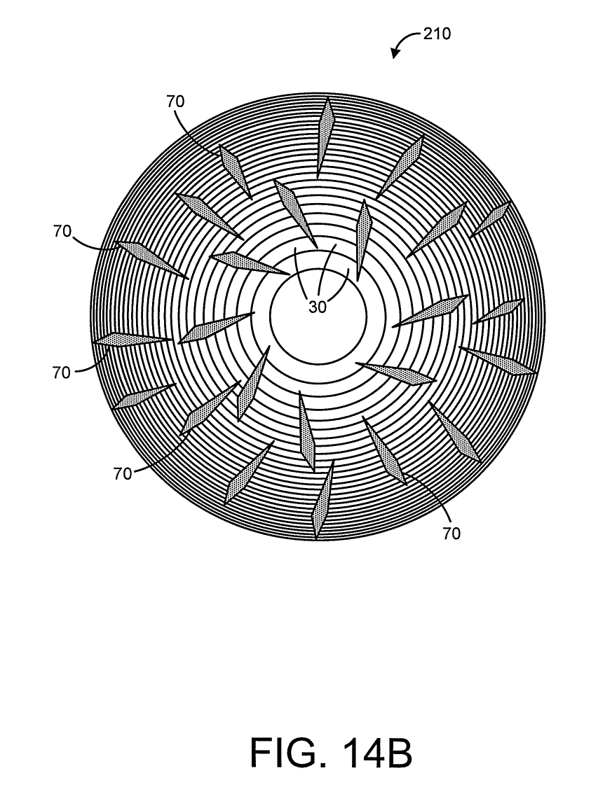

In FIGS. 14A and 14B, the cut pieces 30 bridges 70, and adhesive 60 are secured and set into a final product 210. In FIG. 14B an aesthetic and functional arrangement of bridges on the outer surface of structure 210 is illustrated. It should be understood that in this and in other figures illustrating bridges 70 (or rib bridges 80), that the bridges may be positioned in any desired location or pattern to achieve a desired structural or aesthetic purpose.

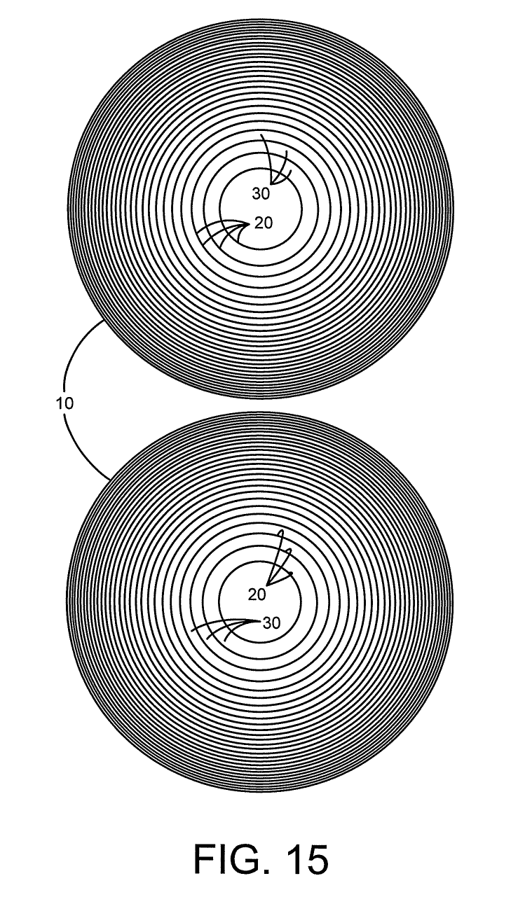

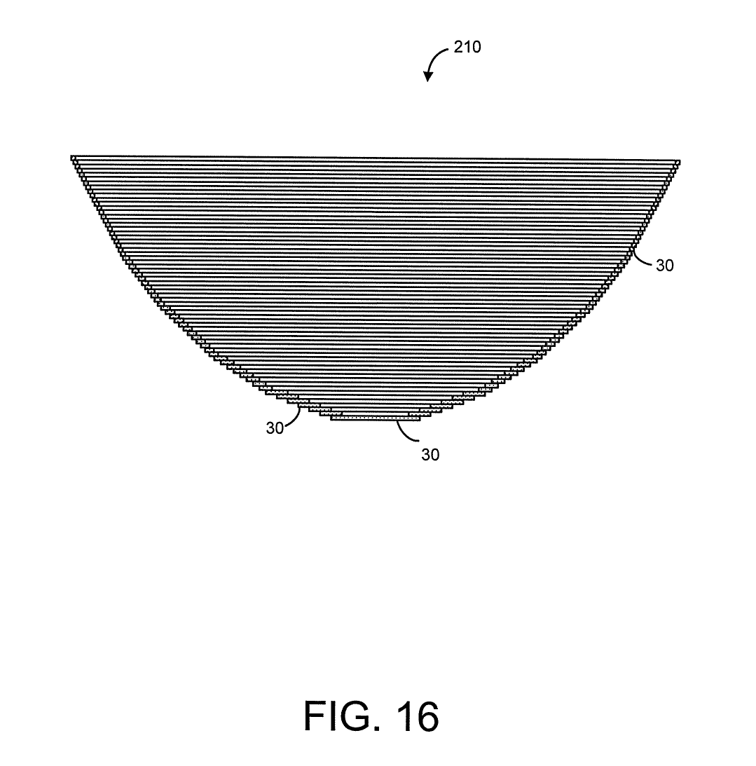

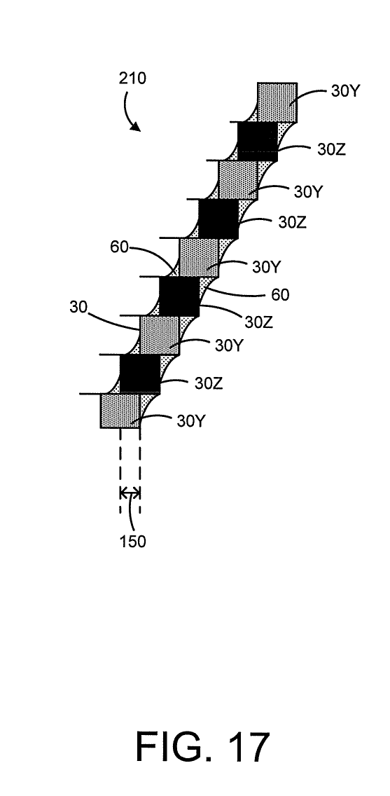

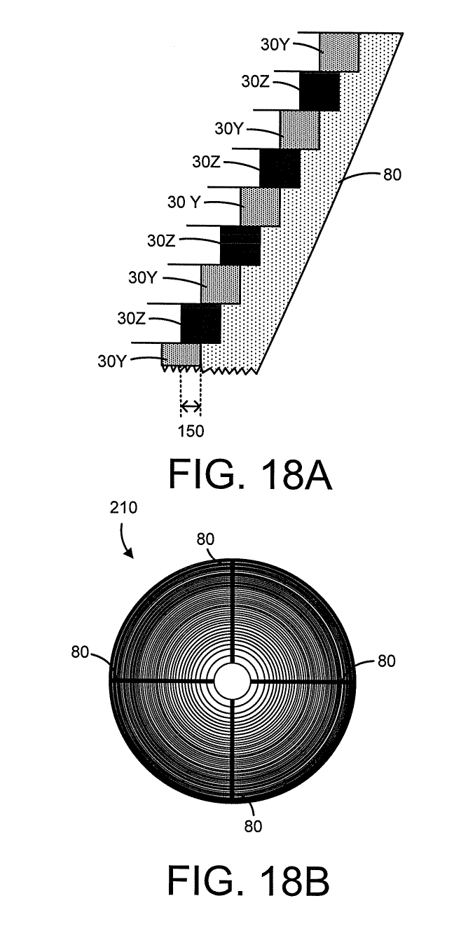

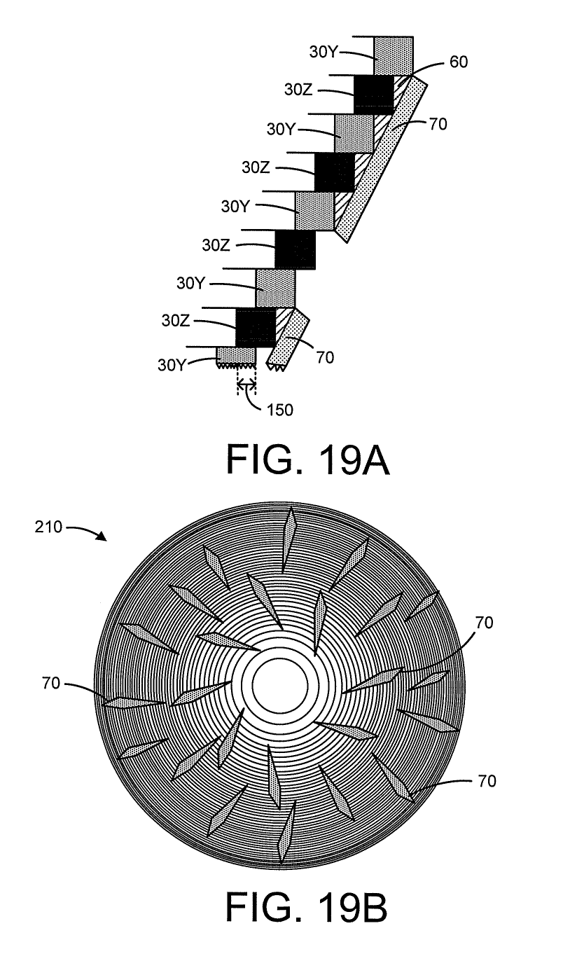

FIGS. 15-21 illustrate an example of a three-dimensional structure derived from plural boards 10. Two boards 10 are illustrated in FIG. 15. The boards illustrated have cuts 20, forming sections 30. The sections may align or alternatively not align, and in the illustrated embodiment, the sections do not align, i.e., although concentric ring cuts 20 are illustrated in both, the radii of the rings 20 in each respective board 10 are not the same. In this way, assembled together, the ring pieces 30 of each board 10 overlap when positioned to form a final product 210. FIG. 16 illustrates a cross sectional view of a three-dimensional structure 210 assembled with the overlapping cut pieces 30 illustrated in FIG. 15. FIGS. 17-19B provide detail views of the structure 210 of FIG. 16, but with different adhering examples used. Overlapping pieces 30 from the two cut boards 10, show an illustrative overlap section 150. As illustrated, the pieces from the two boards are labeled 30Y and 30Z, respectively. FIG. 17 illustrates an example in which adhesive 60 only is used as a securing means. FIGS. 18A and 18B illustrate rib 80 secured sections and FIGS. 19A and 19B illustrate plane bridge 70 secured sections and the use of adhesive 60. Determining which embodiment to employ can depend on the characteristics desired.

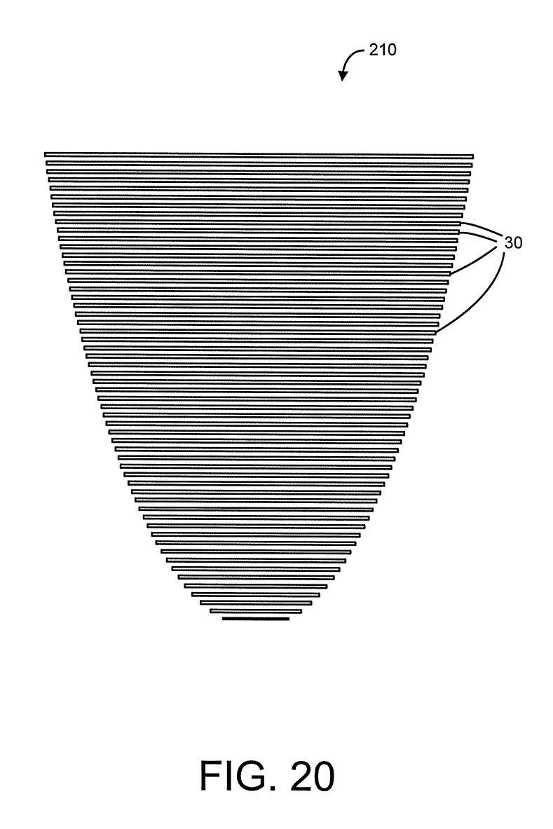

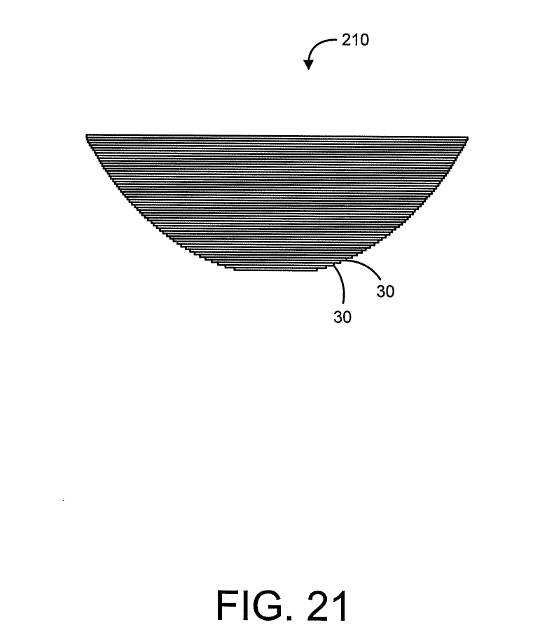

Another example is illustrated in FIG. 20, which is an exploded view of final product 210 made from multiple boards 10. FIG. 21 shows a final product 210 made from multiple boards 10 in an assembled state.

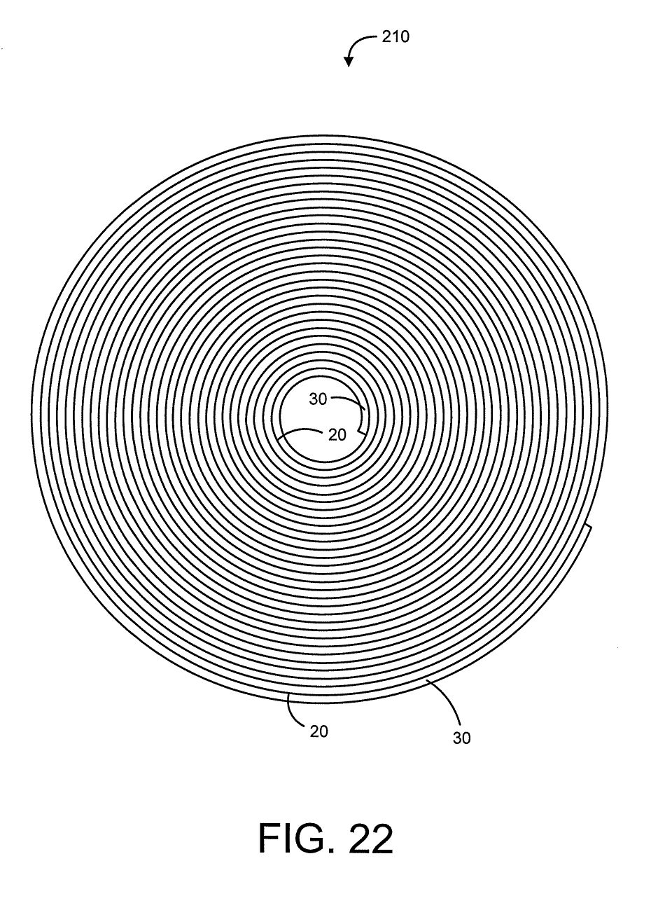

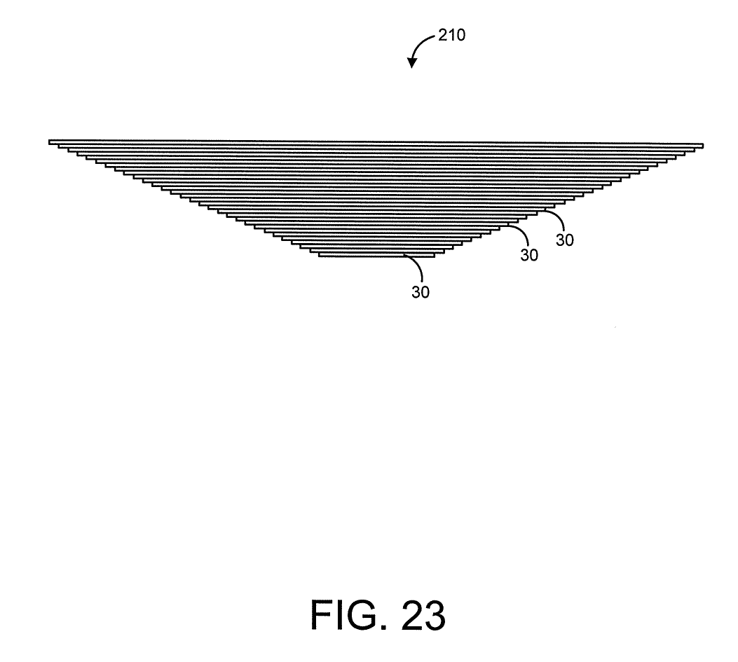

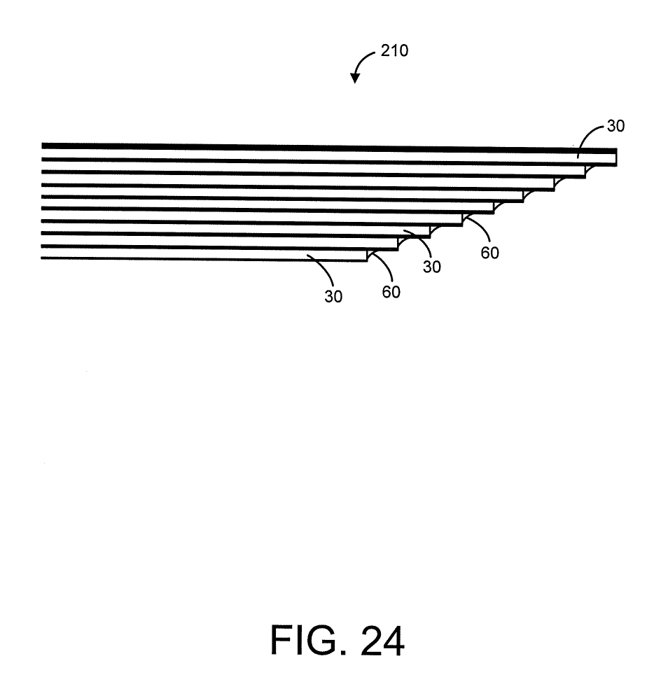

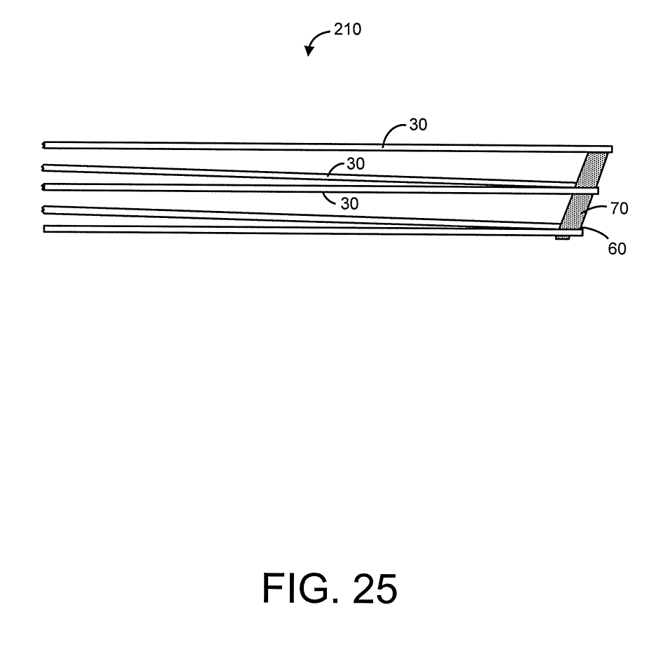

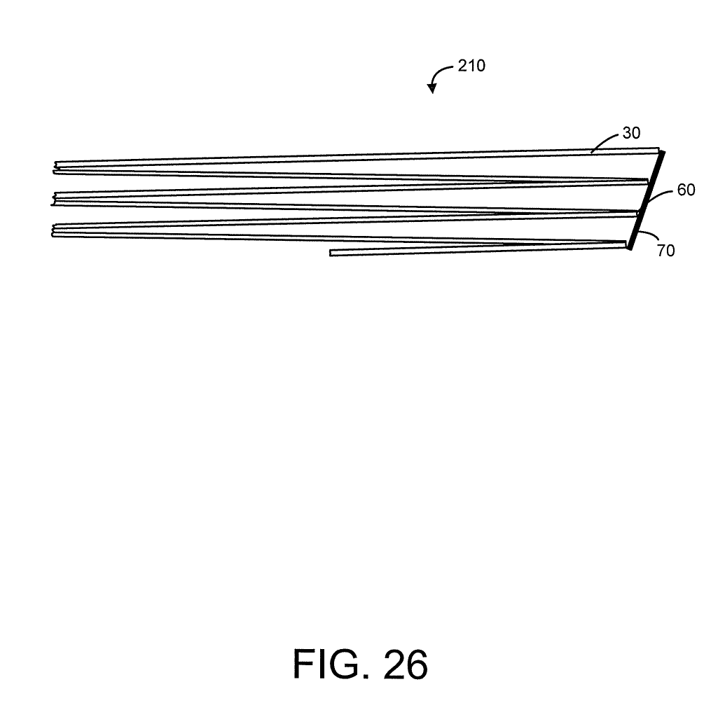

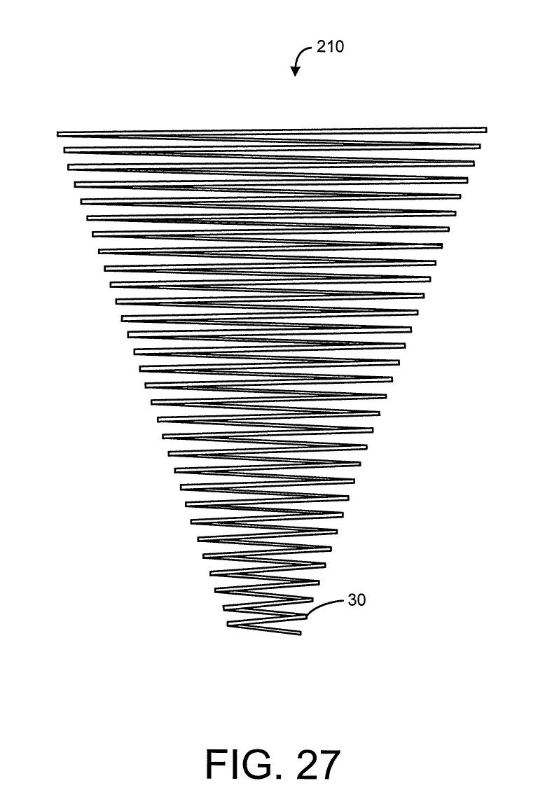

Another example is illustrated in FIGS. 22 to 28. In this example, a single-cut board 10 is used. As already described herein, board 10 optionally is provided with continuous cut 20 that spirals from an outer edge into the interior. The resulting continuous cut piece 30 is a spiral and can be elevated to form a spring-like shape as illustrated in FIG. 27. Likewise a resulting final three-dimensional shape is shown in FIG. 23, and detailed views in FIGS. 24-26. The structure illustrated in FIG. 23 includes the single cut piece 30 retained in an elevated position, such as via use of adhesive, bridges, ribs, etc. In the detail shown in FIG. 24, the structure 210 is secured and set by an adhesive 60 only. In FIG. 25, the structure 210 is set by a combination of adhesive 60 and a rib bridge 70 positioned on an inside surface of the structure, although it should be appreciated that any position of bridge 70, or multiple bridges 70 may be selected. FIG. 26 shows the conical spring final product 210 secured and set by both a plane bridge 70 and adhesive 60. Determining which bridge to use and the location of the bridge, interior 37 or exterior 38, can depend on the characteristics desired in the final product 210.

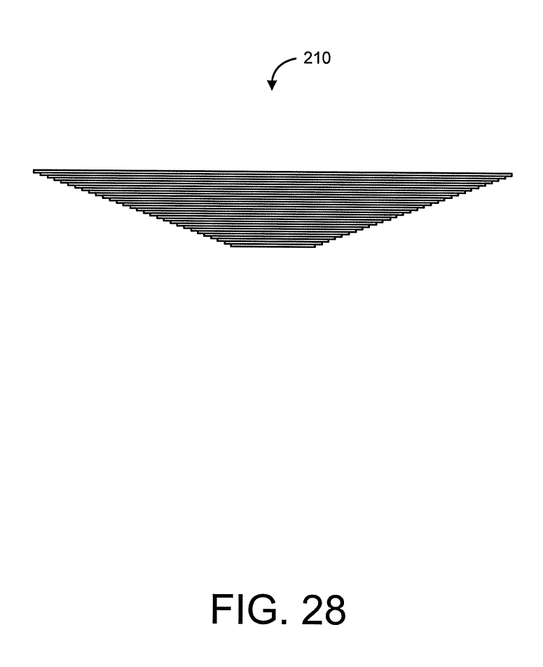

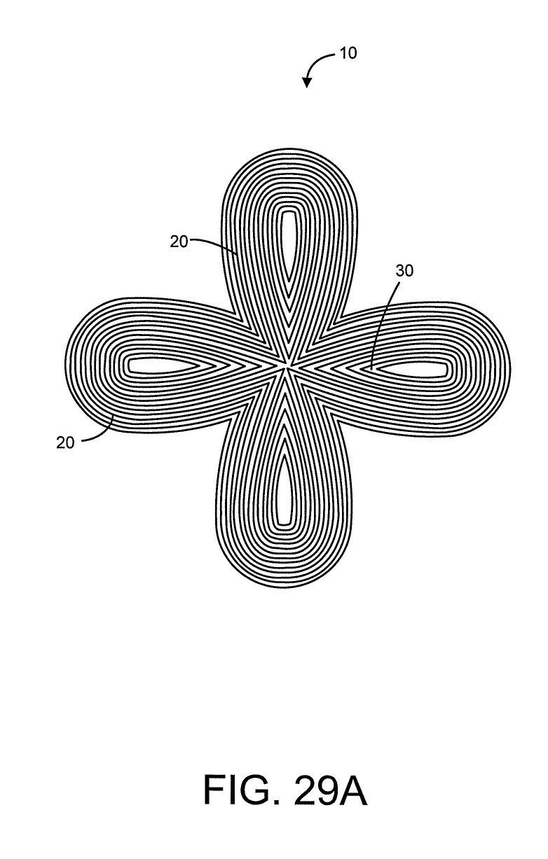

FIG. 28 provides another example of a structure 210.

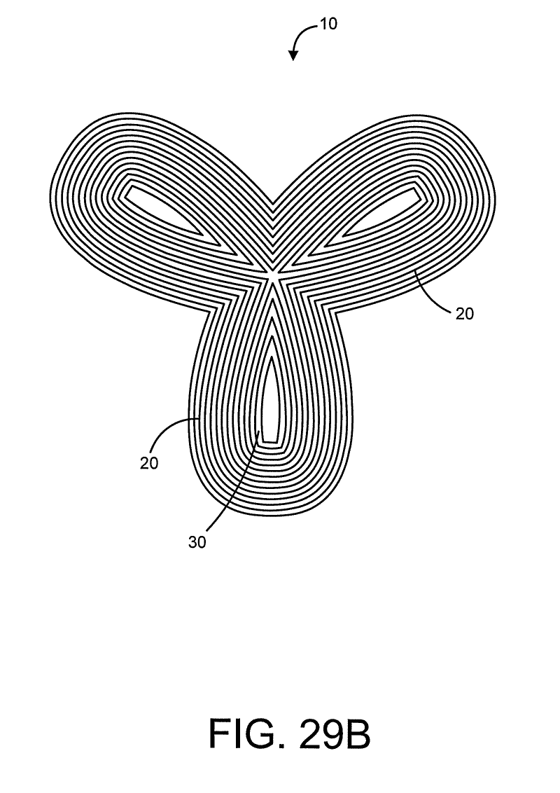

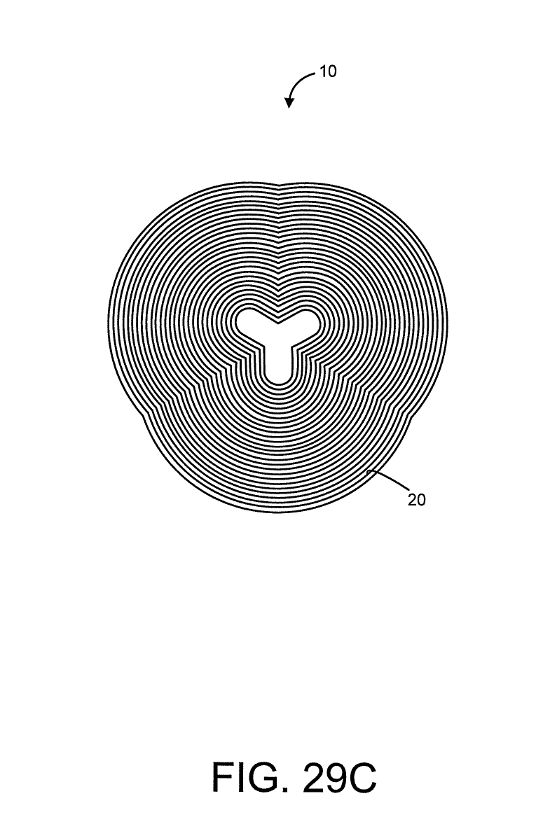

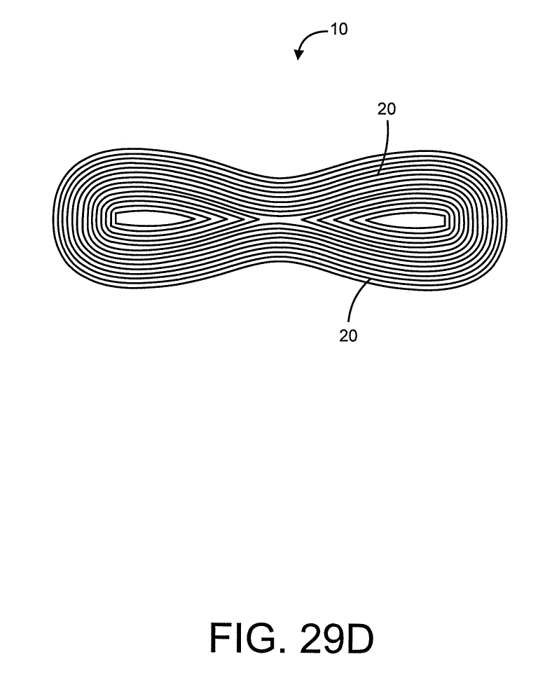

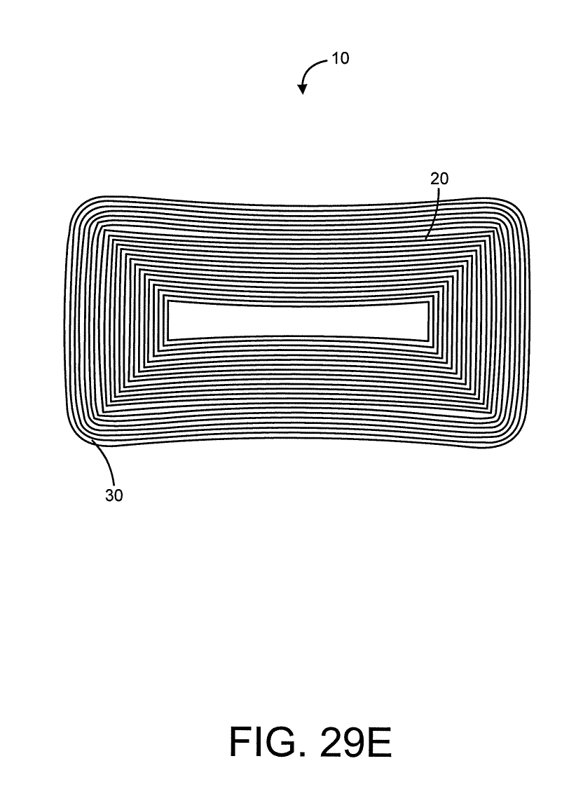

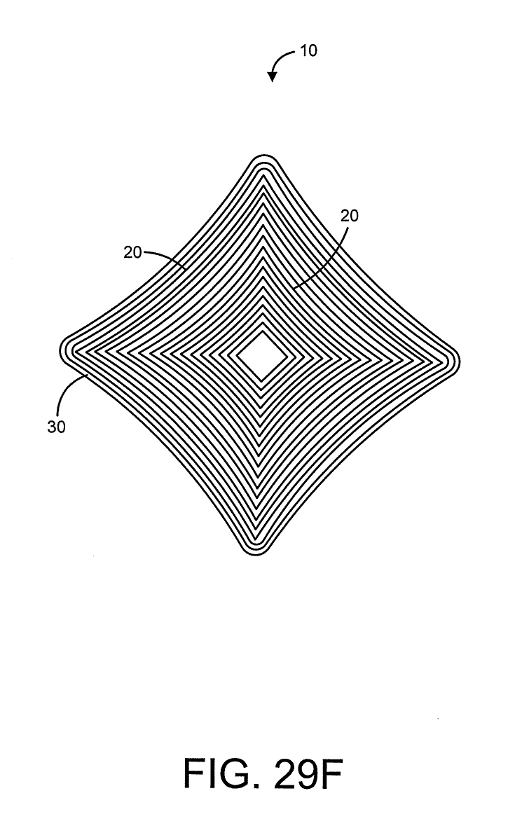

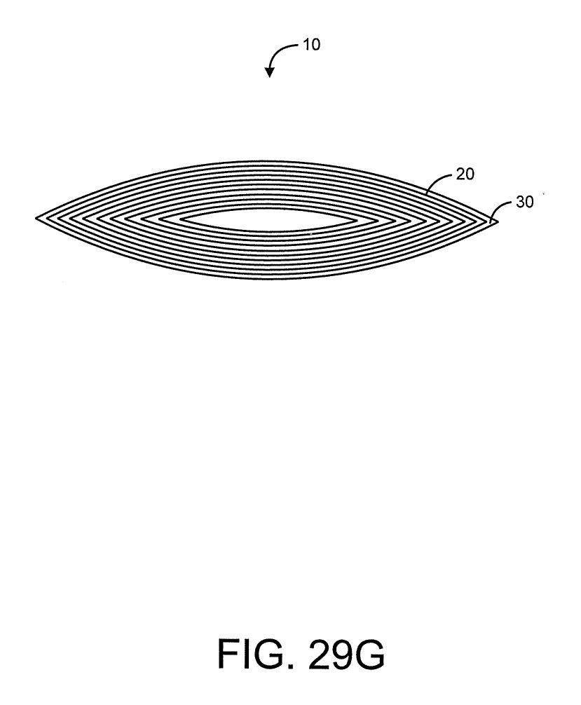

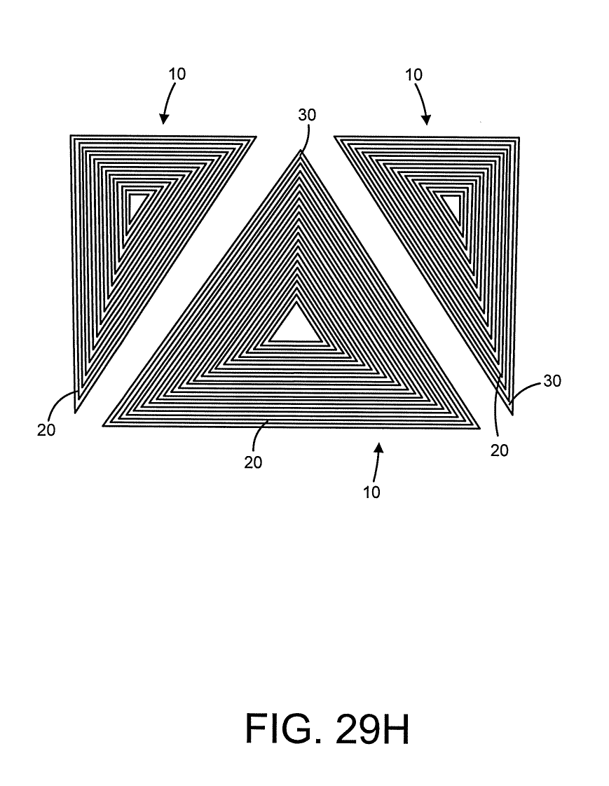

There are numerous geometries and shapes that may be achieved in the present invention. Numerous examples of cut 20 geometries are illustrated in FIGS. 29A through 29H. Examples of varying shapes are illustrated in these figures, although it should be understood that other shapes for final products may be selected. The almost limitless variety of cut 20 patterns can provide the product designer or architect with tools to create a wide variety of structures of both utility and beauty.

The cut 20 patterns may be cut in boards 10 of any starting shape. For example, round or square boards may be provided. Alternatively, using forming technologies discussed herein, greater flexibility in starting board 10 shape may also be achieved, such as utilizing geometrically directed compressed fiber board technologies.

Thus, it is seen that structural and ornamental three-dimensional structures derived from planar boards are provided. It should be understood that any of the foregoing configurations and specialized components or may be interchangeably used with any of the apparatus or systems of the preceding embodiments. Although illustrative embodiments are described hereinabove, it will be evident to one skilled in the art that various changes and modifications may be made therein without departing from the scope of the disclosure. It is intended in the appended claims to cover all such changes and modifications that fall within the true spirit and scope of the disclosure.

What is claimed is:

1. A three-dimensional structure comprising:
a plurality of sections, each section including a substantially planar top surface and a substantially planar bottom surface, the sections oriented in stacked relation with one another; and
an adhesive layer binding the sections in substantially fixed relation with one another.

2. The three-dimensional structure of claim 1 wherein each of the sections includes a first side and second side, the structure further including:
a first one of the sections having a first distance between its first and second sides; and
a second of the sections having a second distance between its first and second sides, the first distance being larger than the second distance; wherein,
the first and second of the sections are oriented in stacked relation with one another.

3. The three-dimensional structure of claim 1 wherein the sections include a plurality of rings, the rings positioned in stacked relation to one another.

4. The three-dimensional structure of claim 3 wherein each of the rings has an outer diameter that is different from the outer diameter of at least one of the rings stacked adjacent to it.

5. The three-dimensional structure of claim 4 wherein each of the rings has an outer diameter that is progressively larger than the outer diameter the ring adjacent to it; and
the three-dimensional structure further including an adhesive applied to the respective sections binding the adjacent sections to one another.

6. The three-dimensional structure of claim 1 wherein the plurality of sections comprise a single section having spirals of radii increasing from a center portion to an outer portion, the structure comprising a single coil and wherein the adhesive binds the spirals in substantially fixed relation to one another.

7. A method of forming a three-dimensional structure comprising:
providing a board having substantially flat top and bottom surfaces;
cutting the board, forming a single cut piece;
elevating a portion of the cut piece in relation to another portion of it;
affixing the elevated cut piece in a substantially fixed position.

8. The method of forming the three-dimensional structure of claim 7 wherein affixing the elevated cut piece further includes applying a binder and allowing it to set.

9. The method of forming the three-dimensional structure of claim 8 further comprising:
providing at least one bridge;
positioning each of the at least one bridge between two portions of the cut piece;
affixing the bridge in place by the application of adhesive.

10. The method of forming the three-dimensional structure of claim 7 wherein the substantially planar board is made from engineered molded fiberboard.

11. The method of forming the three-dimensional structure of claim 7 wherein the affixing includes application of an adhesive resin that contains a coloring.

12. The method of forming a three-dimensional structure comprising:
providing a plurality of sections, each said section having a substantially planar upper surface and a substantially planar bottom surface;
positioning the sections on a retainer;
applying an adhesive to bind the sections in substantially fixed relation to one another.

13. The method of forming a three-dimensional structure of claim 12 wherein:
positioning the sections on a retainer includes positioning the sections in stacked relation to one another and wherein there is overlap between the adjacent surfaces of at least two adjacent said sections; and
applying the adhesive includes binding a first of the sections to a second of the sections by applying the adhesive to overlapping portions of the top surface of the first section to the adjacent bottom surface of the second section.

14. The method of forming a three-dimensional structure of claim 12 wherein:
positioning the sections on a retainer includes positioning the sections in stacked relation to one another and wherein there is no overlap between the adjacent surfaces of at least two of the adjacent sections; and
applying the adhesive includes binding said non-overlapping adjacent sections to one another by forming an adhesive bridge between the sections.

15. The method of forming the three-dimensional structure of claim 12 further comprising:
positioning one or more bridges between at least two sections, and
affixing the bridges by applying an adhesive.

16. The method of forming the three-dimensional structure of claim 12 wherein the substantially planar board includes molded fiberboard.

17. The method of forming the three-dimensional structure of claim 12 wherein applying the adhesive includes applying a resin.

18. The method of forming the three-dimensional structure of claim 12 further comprising providing a rib bridge secured to an outer wall of the one or more cut pieces, wherein the rib bridge longitudinally extends the full length of an outer wall of the structure.

19. The method of forming the three-dimensional structure of claim 12 further comprising providing a rib bridge secured to an inner wall of the one or more cut pieces, wherein the rib bridge longitudinally extends the full length of an inner wall of the structure.
